(19) United States
(12) Patent Application Publication
(10) Pub. No.: US 2017/0331215 A1
(43) Pub. Date: Nov. 16, 2017

(54) Electrical Outlet Plate and Plug

(71) Applicant: Michael Glotzbach, Erie, PA (US)

(72) Inventor: Michael Glotzbach, Erie, PA (US)

(21) Appl. No.: 15/597,070

(22) Filed: May 16, 2017

Related U.S. Application Data
(60) Provisional application No. 62/337,295, filed on May 16, 2016.

(51) Int. Cl. H01R 13/443; H01R 24/76

(52) U.S. Cl. CPC H01R 13/443; H01R 24/76

(57) ABSTRACT

A cover for an electrical outlet socket comprises a socket cover that has prongs that fit into the power receptacles of a standard electrical outlet socket. A connection device is used to mount the cover to an electrical outlet faceplate. The connection device comprises a mount for mounting the cover to the electrical outlet faceplate, a support arm that connects the socket cover to the mount, and a living hinge between the socket cover and the connection device. The mount has an opening to receive the existing screw from the electrical outlet faceplate. Various embodiments may have multiple socket covers wherein the support arm connects both each socket cover to the mount.

### BACKGROUND

Electrical outlets are a safety hazard for households that have small children. There are many safety covers and plugs that exist in the prior art but those have limitations that make them easy to lose if not in use, difficult to install, too difficult to use, or expensive. What is presented are electrical outlet covers that are mounted directly to the faceplate of the electric outlet and remain attached to the faceplate when the cover is not in use.

### SUMMARY

What is presented is a cover for an electrical outlet socket comprising a socket cover that has prongs that fit into the power receptacles of a standard electrical outlet socket and a connection device. The connection device comprises a mount that mounts the cover to an electrical outlet face plate that is modified to have an attachment location and a living hinge incorporated between the socket cover and the connection device. The living hinge allows the socket cover to be moved out of the way of the electrical outlet socket when the socket cover is not in use. In various embodiments, the mount can be a compression connection, adhesives, a weld, a pin, a nail, or a screw device that mounts to the attachment location.

In another embodiment, a cover for an electrical outlet socket comprises a socket cover that has prongs that fit into the power receptacles of a standard electrical outlet socket. A connection device is used to mount the cover to an electrical outlet faceplate. The connection device comprises a mount for mounting the cover to the electrical outlet faceplate, a support arm that connects the socket cover to the mount, and a living hinge between the socket cover and the connection device. The mount has an opening to receive the existing screw from the electrical outlet faceplate. Various embodiments may have multiple socket covers wherein the support arm connects both each socket cover to the mount. Common configurations are covers that have two or four socket covers.

Those skilled in the art will realize that this invention is capable of embodiments that are different from those shown and that details of the apparatus and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF DRAWINGS

For a more complete understanding and appreciation of this invention, and its many advantages, reference will be made to the following detailed description taken in conjunction with the accompanying drawings.

FIG. 1 is a front perspective view of an electrical outlet cover that has a mount that mounts to standard electrical outlet faceplate;

FIG. 2 is a rear perspective view of the electrical outlet cover of FIG. 1;

FIG. 3 is a top view of the electrical outlet cover of FIG. 1;

FIG. 4 is a cut out view of the electrical outlet cover of FIG. 1 installed on a standard electrical outlet faceplate with one removed from an outlet and a second cover installed in an outlet;

FIG. 5 is a perspective view of two covers according to another embodiment in which one cover is being installed in a modified electrical outlet faceplate and a second outlet cover is installed and secured to a modified faceplate cover; and

FIG. 6 is a cross sectional view of an outlet cover of FIG. 5 showing the connection device installed on an attachment location of a modified faceplate cover.

### DETAILED DESCRIPTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

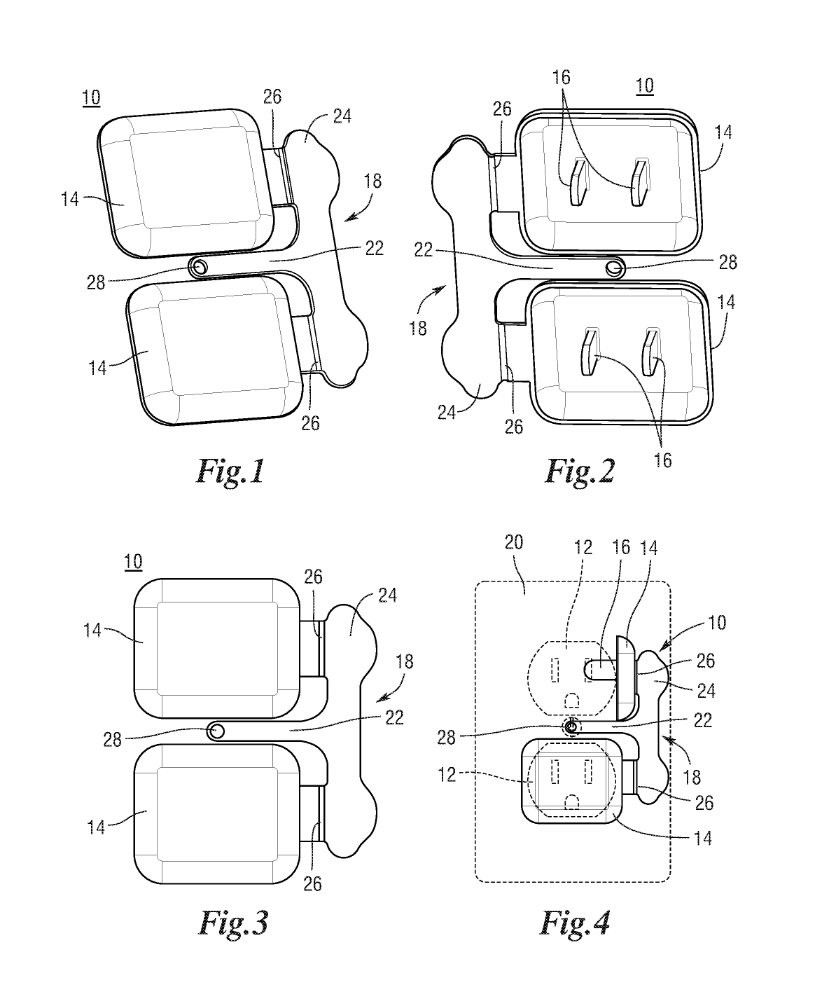

As best understood by comparing FIGS. 1 through 4, one embodiment of a cover 10 for an electrical outlet socket 12 comprises a number of socket covers 14 that are each sized to fit into the power receptacles 16 of a standard electrical outlet socket 12. Each socket cover 14 has a pair of prongs 16 that correspond to the socket openings of the electrical outlet socket 12. The prongs 16 are sized and shaped to secure the socket cover 14 to the electrical outlet socket 12 such that it may not be easily removed from the electrical outlet socket 12 by a child. The embodiment shown has two prongs but could have a different number of prongs.

The cover 10 has a connection device 18 for mounting the cover 10 to the electrical outlet faceplate 20 that covers the electrical outlet socket 12. The connection device 18 comprises a mount 22 for mounting the cover 10 to the electrical outlet faceplate 20 and a support arm 24 that connects each socket cover 14 to the mount 22. A living hinge 26 is incorporated between each socket cover 14 and the support arm 24 of the connection device 18. The mount 22 has an opening 28 to receive the existing screw (not shown) from the electrical outlet faceplate 20 in order to secure the cover 10 to the electrical outlet faceplate 20. However, it should be understood that any other type of system that attaches the cover 10 to the electrical outlet faceplate 20 making it a permanent or semi-permanent attachment may be used, such as adhesives, welding, pins, nails, or screws.

The shape of the socket cover 14 is such that it blocks assess to the socket openings of the electrical outlet socket 12 to which it is mounted. The actual shape could be varied in the particular end design so long as it provides the safety function required by similar socket covers.

The socket cover 14 has a pair of prongs 16 that correspond to the socket openings of the electrical outlet socket 12. The prongs 16 are sized and shaped to secure the socket cover 14 to the electrical outlet socket 12 such that it may not be easily removed from the electrical outlet socket 12 by a child. The embodiment shown has two prongs but could have a different number of prongs.

The living hinge 26 allows the socket cover 14 to be moved out of the way to allow access to the electrical outlet socket 12 but remain attached to the support arm 24 when the socket cover 14 is not in use. This eliminates the risk of misplaced socket covers that are not so attached to the faceplate.

The embodiments shown in FIGS. 1 through 4 show a cover 10 that comprises two socket covers 14 with the support arm 24 connecting both socket covers 14 to the mount 22 and that the mount 22 is centrally located on the electrical outlet faceplate 20 between two electrical outlet sockets 12. However, it will be understood that the number of socket covers 14 and the location of the mount 22 can be varied according to the number and layout of outlet sockets 12 and the location of the screw for mounting the electrical outlet faceplate 20. The configurations for electrical outlets can vary but electrical outlet sockets comprising two or four individual electrical outlet sockets are the most common.

The cover 10 may be made from polycarbonate, any type of thermoplastic, thermoset, metal, wood, or natural material. The cover 10 could be made using an injection molding process, by extrusion, injection blow molding, extrusion blow molding, compression molding, thermoforming, rotational molding, carving, cutting, CNC, 3-D printing or metal work. The cover 10 could also be colored, tinted, or otherwise decorated using hot stamping, silk screening, labeled, laser printing, etching, in mold decoration, engraving, burning, or paint.

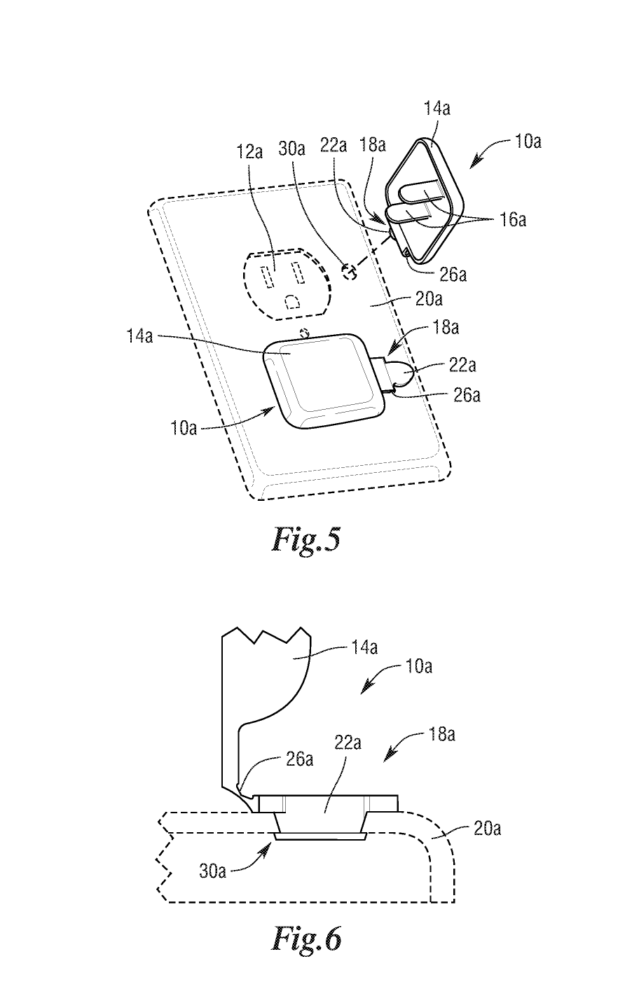

Another embodiment of cover 10a is shown in FIGS. 5 and 6. In this embodiment, the connection device 18a has a mount 22a that requires that the electrical outlet faceplate 20a be modified to have an attachment location 30a that receives the mount 22a. A connection device 18a also has a living hinge 26a that connects to the socket cover 14a and allows the socket cover 14a to be moved out of the way of the electrical outlet socket 12a when the socket cover 14a is not in use. The mount 22a keeps the cover 10a attached to the electrical outlet faceplate 20a when the socket cover 14a is not in use. This eliminates the risk of misplaced socket covers that are not so attached to the faceplate.

The shape of the socket cover 14a is such that it blocks assess to the socket openings of the electrical outlet socket 12a to which it is mounted. The actual shape could be varied in the particular embodiment so long as it provides the safety function required by similar socket covers.

The socket cover 14a has a pair of prongs 16a that correspond to the socket openings of the electrical outlet socket 12a. The prongs 16a are sized and shaped to secure the socket cover 14a to the electrical outlet socket 12a such that it may not be easily removed from the electrical outlet socket 12a by a child. The embodiment shown has two prongs but could have a different number of prongs.

The cover 10a may be made from polycarbonate, any type of thermoplastic, thermoset, metal, wood, or natural material. The cover 10a could be made using an injection molding process, by extrusion, injection blow molding, extrusion blow molding, compression molding, thermoforming, rotational molding, carving, cutting, CNC, 3-D printing, or metal work. The cover 10a could also be colored, tinted, or otherwise decorated using hot stamping, silk screening, labeled, laser printing, etching, in mold decoration, engraving, burning, or paint.

The mount 22a shown in FIGS. 5 and 6 is a compression connection that fits into the attachment location 30a that requires the electrical outlet faceplate 20a to be modified. However, it should be understood that any other type of system that attaches the cover 10a to the electrical outlet faceplate 20a making it a permanent or semi-permanent attachment may be used, such as adhesives, welding, pins, nails, or screws. Some of these alternatives do not require modification of the electrical outlet faceplate 20a and those that do could be sold to the consumer with faceplates that are already modified or with instructions that may include tools to modify existing faceplates to accept the corresponding mounts in the particular embodiment.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

What is claimed is:

1. A cover for an electrical outlet socket comprising:
a socket cover having prongs sized to fit into the power receptacles of a standard electrical outlet socket; and
a connection device comprising
a mount for mounting the cover to an electrical outlet faceplate that is modified to have an attachment location; and
a living hinge between said socket cover and said connection device.

2. The cover of claim 1 in which said mount is one of a compression connection, adhesives, a weld, a pin, a nail, or a screw.

3. An electrical outlet faceplate comprising:
at least one opening for an electrical outlet socket;
each opening having a corresponding adjacent attachment location for receiving a connection device; and
each opening having a corresponding cover that comprises:
a socket cover having prongs sized to fit into the power receptacles of a standard electrical outlet socket;
a connection device comprising:
a mount for mounting said cover to said attachment location; and
a living hinge between said socket cover and said connection device

4. A cover for an electrical outlet socket comprising:
a socket cover having prongs sized to fit into the power receptacles of a standard electrical outlet socket;
a connection device for mounting the cover to an electrical outlet faceplate;
said connection device comprises:
a mount for mounting the cover to the electrical outlet faceplate;
a support arm that connects said socket cover to said mount; and
a living hinge between said socket cover and said connection device; and
said mount having an opening to receive the existing screw from the electrical outlet faceplate.

5. The cover of claim 1 comprising two socket covers wherein said support arm connects both said socket covers to said mount.

6. The cover of claim 1 comprising four socket covers wherein said support arm connects each said socket cover to said mount.
